(19) United States
(12) Patent Application Publication
(10) Pub. No.: US 2003/0151685 A1
(43) Pub. Date: Aug. 14, 2003

(54) Digital video camera having only two CCDs

(76) Inventor: Marcus J. Ia Grone, Cushing, OK (US)

Correspondence Address: DUNLAP, CODDING & ROGERS P.C., PO BOX 16370, OKLAHOMA CITY, OK, 73114, US

(21) Appl. No.: 10/364,595

(22) Filed: Feb. 11, 2003

Related U.S. Application Data
(60) Provisional application No. 60/356,599, filed on Feb. 11, 2002.

(51) Int. Cl. H04N 5/225; H04N 9/09

(52) U.S. Cl. 348/262; 348/273

(57) ABSTRACT

A 4:2:2 RGB, or YCrCb camera, comprising two photodetectors, a prism, and a filter mask. The prism receives light indicative of an image. The prism splits the light into a first light beam and a second light beam. The first light beam is a first color and is directed to one of the photodetectors. The filter mask has a predetermined pattern of a second color and a third color. The second filter mask receives the second light beam and transmits light of the first and second colors in the second light beam to the other one of the photodetectors.

### CROSS REFERENCE TO RELATED APPLICATIONS

The present application claims priority under 35 U.S.C. §119 (e) to the provisional patent application identified by U.S. Ser. No. 60/356,599, filed on Feb. 11, 2002 and entitled “Digital Video Camera Having Only Two CCDs”, the entire content of which is hereby incorporated herein by reference.

### STATEMENT REGARDING FEDERALLY SPONSORED RESEARCH OR DEVELOPMENT

Not applicable.

### BACKGROUND OF THE INVENTION

Professional television and digital cinema cameras use three CCDs in order to capture a higher quality image than single CCDs cameras can offer. The standards for video, however, dictate that this image is sub-sampled, and as a result about one-third of the data is not preserved.

Three CCD cameras commonly use a prism to split the light into red, green, and blue and use a separate CCD for each of these colors. This guarantees that each pixel has all the data it needs to reconstruct the image without having to sacrifice image sharpness. The disadvantage is the cost and complexity of using, aligning and mounting three CCDs.

Single CCD cameras use a bayer pattern (or other comparable) to develop a color image. As there is not enough information at each pixel, data has to be interpolated in order to fill in the blanks. This leads to a decrease in sharpness (apparent resolution) and also greatly contributes to undesirable optical artifacts (Moiré patterns, for example).

There is a need for an improved camera which has greater sharpness (apparent resolution) and less optical artifacts than a single CCD camera, but avoids the cost and complexity of using, aligning and mounting three CCDs. It is to such an improved camera that the present invention is directed.

### BRIEF DESCRIPTION OF THE DRAWINGS

FIG. 1 is a top plan view, partially in diagrammatic form, of a camera constructed in accordance with the present invention.

FIG. 2 is a perspective view of one version of a photo detector having a filter mask formed thereon in accordance with the present invention.

FIG. 3 is a perspective view of another version of a photo detector having a filter mask formed thereon.

FIG. 4 is a perspective view of yet another embodiment of a photo detector having a filter mask formed, thereon in accordance with the present invention.

### DETAILED DESCRIPTION OF THE INVENTION

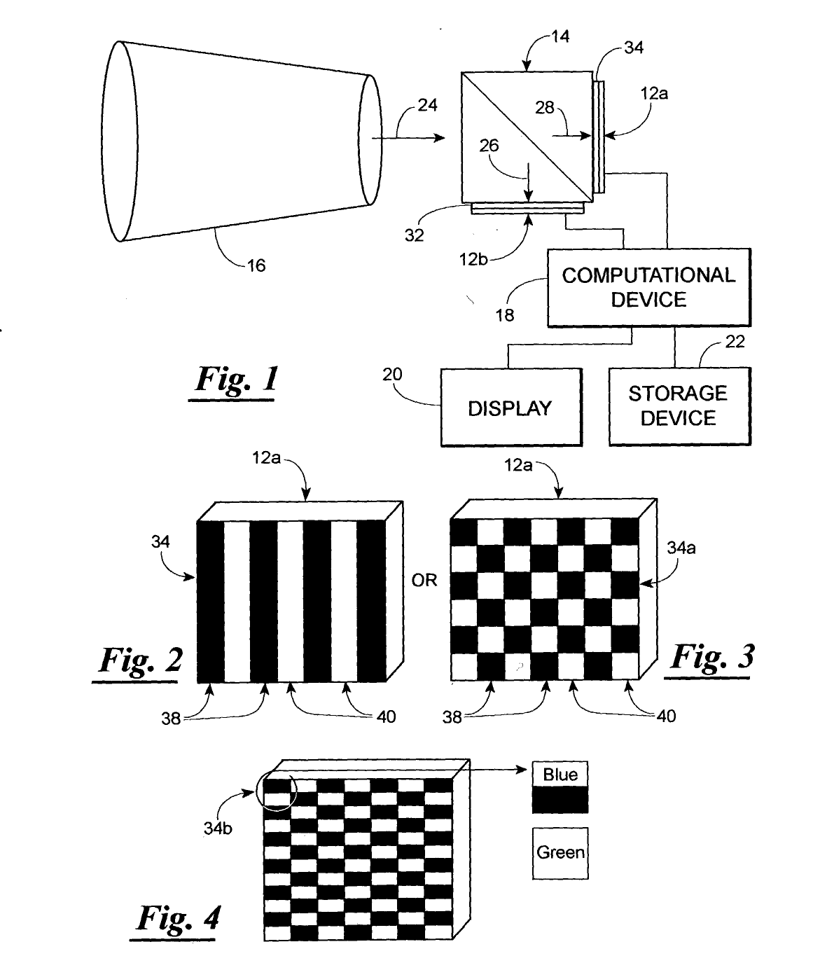

Referring now to the drawings, and in particular to FIG. 1, shown therein and designated by a reference numeral 10, is a camera constructed in accordance with the present invention. The camera 10 can be used for most video applications due to the way current SD and HD video standards encode the data. In general, the camera 10 is provided with two photo detectors (designated by the reference numerals 12a and 12b), a light directing device 14, a lens 16, a computational device 18, a display 20, and a storage device 22.

The lens 16 of the camera 10 receives light 24 indicative of an image and focuses the light 24 towards the light directing device 14. The construction and use of the lens 16 is well known in the art. Thus, no further comment with respect to the construction and the use of the lens 16 is deemed necessary to teach one skilled in the art how to practice the present invention.

The light directing device 14 receives the light 24 indicative of the image from the lens 16. In response thereto, the light directing device 14 splits or directs the light 24 into a first light beam 26 and a second light beam 28. The light directing device 14 can be a 45° prism with a dichroic mirrors/filters, or a beam splitter.

In one preferred embodiment, the camera 10 is also provided with a first filter mask 32, and a second filter mask 34. The first filter mask 32 receives the first light beam 26 and transmits a first color of light in the first light beam 26 to the photo detector 12b. As will be understood by one skilled in the art, when the light directing device 14 is a prism which separates the first color of light from the light 24, the first filter mask 32 may be eliminated.

Referring now to FIG. 2, in combination with FIG. 1, the second filter mask 34 has a predetermined pattern formed by one or more filtering regions 38 of a second color and one or more filtering regions 40 of a third color. The second filter mask 34 receives the second light beam 28 and transmits light of the first and second colors in the second light beam 28 to the photo detector 12a.

The second filter mask 34 can be implemented in many different ways. For example, as shown in FIG. 2, the second filter mask 34 can be applied directly onto the photo detector 12a such as by photolithography techniques, ink jet printing techniques, or other manners of applying or printing a shadow mask to the photo detector 12a. Alternatively, the second filter mask 34 can also be implemented as a transparent material, such as glass, having the regions 38 and 40 printed thereon with the transparent material positioned between the light directing device 14 and the photo detector 12a.

The photodetectors 12a and 12b can be implemented by any type of light sensitive device capable of receiving light indicative of an image and outputting data indicative of the image. For example, the photodetectors 12a and 12b can be implemented as charge-coupled devices (CCDs), CMOS, photodiodes, phototransistors, a Cadmium-Sulfide cell, or a bolometer.

The regions 38 and 40 forming the predetermined pattern of the second filter mask 34 can be implemented in many forms. For example, as shown in FIG. 2, the predetermined pattern can be implemented as a plurality of alternating stripes of the regions 38 and 40. In this instance, each of the alternating stripes is applied to the photodetector 12a to create a shadow mask for a predetermined number of pixels on the photodetector 12a. For example, each stripe can be applied to one, two or three, column(s) or row(s) of pixels on the photodetector 12a.

Shown in FIG. 3 and designated by a reference numeral 34a is another embodiment of a second filter mask applied to the photodetector 12a. The second filter mask 34a is similar in construction and function as the second filter mask 34, except that the predetermined pattern of the regions 38 and 40 is in the form of a checker board. In this instance, the regions 38 and 40 are sized so as to form a plurality of uniformly sized square areas. Each of the square areas can cover or be applied to one or more pixels of the photodetector 12a.

Shown in FIG. 4 and designated by a reference numeral 34b is another embodiment of a second filter mask applied to the photodetector 12a. The second filter mask 34b is similar in construction and function as the second filter mask 34a, except the checker board pattern of the regions 38 and 40 are sized and positioned to form a plurality of uniformly distributed rectangular areas. One advantage of this is that is lowers spatial noise, such as Moiré patterns.

The photo detectors 12a and 12b receive the portions of the light discussed above, and output signals to the computational device 18 indicative of the light received by the photo detectors 12a and 12b. The computational device 18 is programmed to convert the signals produced by the photo detectors 12a and 12b into an image. The computational device 18 can be a digital signal processor, central processing unit, micro controller or other type of digital processing device capable of running software to convert the signals produced by the photo detectors 12a and 12b into the image.

Once the computational device 18 has formed the image, such image can be transmitted to the display 20, or the storage device 22. The display 20 can be any type of visual display, such as an LCD screen, standard definition monitor or television, high definition monitor or television, or the like. The storage device 22 can be any type of computer readable medium, such as a random access memory, magnetic storage device, optical storage device, or the like.

In one preferred embodiment, the camera 10 can be characterized as a 4:2:2 RGB camera. In this instance, the first color is “green”, the second color is “red” and the third color is “blue”. The photodetector 12b is devoted to what is commonly referred to in the art as the “green” channel of the 4:2:2 RGB camera. In one preferred embodiment, the photodetector 12b is entirely devoted to the “green” channel. The photodetector 12a forms both the red and blue channels of the 4:2:2 RGB camera. By using a two-photodetector 12a and 12b arrangement, one for the “green” channel and one that shares both the “red” and “blue” channels, one can capture images with the sharpness of a three CCD camera with no worse color depth than the normal video standard. This permits fewer CCDs and less expensive optics for the same apparent quality.

Using 2 photodetectors 12a and 12b also permits one to use a simple 45 degree prism with dichroic mirrors/filters (i.e., the light directing device 14). This makes manufacture easier, alignment easier and light throughout higher.

A variation would be to let the “green” CCD filter see some of the red and blue. Thus, one would have a YRB camera. The advantage: easier, more accurate conversion to YCrCb space. Work has been done previously with WRB (white, red, blue) cameras on single CCDs and the results were not desirable as the “white” areas received much more light than the other areas, making it difficult to balance the signal levels. By doing this on two separate channels, balance and “bleedover” from adjacent pixels that plagued single CCD WRB cameras is eliminated. As the Y (or W) channel is the one humans are most sensitive to, the fact that more energy is on a single CCD means its signal-to-noise ratio will be much improved at only a minor expense to the red and blue channels.

Other variations one could use would be to use Cyan and Yellow rather than blue and red filters.

As background,

YCrCb is (approx.) Y=Green+some red and some blue (Luminance),

Cr=Red−Y, Cb=Blue−Y

4:4:4 refers to the sampling of YCrCb where Y, Cr and Cb all get equal sampling.

4:2:2 sampling is where Y gets full sampling but Cr and Cb are only sampled at half the base rate across the image.

As a result, if you have:

720×480 4:4:4 RGB 720×480 Red, 720×480 Green and 720×480 blue

720×480 4:4:4 YCrCb 720×480 Y, 720×480 Cr, 720×480Cb

720×480 4:2:2 YCrCb 720×480 Y, 360×480 Cr, 360×480Cb

Changes may be made in the embodiments of the invention described herein, or in the parts or the elements of the embodiments described herein or in the step or sequence of steps of the methods described herein, without departing from the spirit and/or the scope of the invention as defined in the following claims.

What is claimed is:

1. A camera, comprising:
two photodetectors;
means for receiving light indicative of an image and for splitting the light into a first light beam and a second light beam;
a first filter mask receiving the first light beam and transmitting a first color of light in the first light beam to one of the photodetectors; and
a second filter mask having a plurality of regions forming a predetermined pattern of a second color and a third color, the second filter mask receiving the second light beam and transmitting light of the second and third colors in the second light beam to the other one of the photodetectors.

2. The camera of claim 1, wherein at least one of the photodetectors is a charge-coupled device.

3. The camera of claim 1, wherein the predetermined pattern of the second filter mask is in a form of a checkerboard.

4. The camera of claim 1, wherein the predetermined pattern of the second filter mask is in a form of alternating stripes.

5. The camera of claim 1, wherein the camera is characterized as a 4:2:2 camera.

6. The camera of claim 1, wherein the first color is green, the second color is blue, and the third color is red.

7. The camera of claim 1, wherein the first color, second color and third color represent YcrCb.

8. The camera of claim 1, wherein the first color is white.

9. A camera, comprising:
two photodetectors;
a prism receiving light indicative of an image and for splitting the light into a first light beam and a second light beam, the first light beam being a first color and being directed to one of the photodetectors;
a filter mask having a predetermined pattern of a second color and a third color, the second filter mask receiving the second light beam and transmitting light of the first and second colors in the second light beam to the other one of the photodetectors.

10. The camera of claim 9, wherein at least one of the photodetectors is a charge-coupled device.

11. The camera of claim 9, wherein the predetermined pattern of the filter mask is in a form of a checkerboard.

12. The camera of claim 9, wherein the predetermined pattern of the filter mask is in a form of alternating stripes.

13. The camera of claim 9, wherein the camera is characterized as a 4:2:2 camera.

14. The camera of claim 9, wherein the first color is green, the second color is blue, and the third color is red.

15. The camera of claim 9, Wherein the first color, second color and third color represent YcrCb.

16. The camera of claim 9, wherein the first color is white.

17. A method for producing a 4:2:2 camera using only two photodetectors, comprising the steps of:
splitting light indicative of an image into a first light beam and a second light beam, the first light beam being a first color;
receiving the first light beam by one of the two photodetectors;
filtering the second light beam to form the second light beam into a second color and a third color; and
directing the second color and third color of light from the second light beam onto the other one of the photodetectors.
